(19) United States
(12) Patent Application Publication
(10) Pub. No.: US 2013/0328429 A1
(43) Pub. Date: Dec. 12, 2013

(54) Motor Unit, and Dynamo-Electric Machine and Dynamo-Electric Machine Device that Use Same

(71) Applicants: Yuji Enomoto, Hitachi (JP); Zhuonan Wang, Hitachi (JP); Ryoso Masaki, Narashino (JP)

(72) Inventors: Yuji Enomoto, Hitachi (JP); Zhuonan Wang, Hitachi (JP); Ryoso Masaki, Narashino (JP)

(73) Assignee: Hitachi Industrial Equipment Systems Co., Ltd., Chiyoda-ku, Tokyo (JP)

(21) Appl. No.: 13/981,846

(22) PCT Filed: Dec. 20, 2011
(86) PCT No.: PCT/JP2011/079522

§ 371 Date: Aug. 27, 2013

(30) Foreign Application Priority Data
Jan. 26, 2011 (JP) 2011-013900

(51) Int. Cl. H02K 16/02; H02K 1/27

(52) U.S. Cl. CPC H02K 16/02; H02K 1/2793
USPC 310/114

(57) ABSTRACT

Provided are: a low cost, high-performance motor unit which has a large capacity obtained without increasing the radial size of the axial gap motor and which can be assembled with improved efficiency; and a dynamo-electric machine and a dynamo-electric machine device which use the motor unit. A motor unit comprises: an in-unit shaft; a stator provided along the circumferential direction of the in-unit shaft; two rotors rotating together with the in-unit shaft and provided so as to face both surfaces of the stator in the circumferential direction; and engagement sections provided to the surface of each of the rotors which is on the side opposite the stator. Such motor units are engaged with each other at the engagement sections and rotate integrally.

### TECHNICAL FIELD

The present invention relates to an axial gap-type motor unit having a gap in the shaft direction, and a dynamo-electric machine and a dynamo-electric machine device that use the same.

### BACKGROUND ART

Recently, the need for energy saving has been emphasized in industrial devices, home appliances, and automobile parts. Almost all of electricity currently generated in domestic thermal, hydraulic, nuclear, or wind power generation plants is produced by dynamo-electric machines (power generators) that are electromagnetic applied products. In addition, more than half of the domestic electricity consumption is consumed by driving the dynamo-electric machines.

Therefore, it is a key point to improve the efficiency of the dynamo-electric machines in order to realize energy saving. Soft magnetic materials are used for iron core sections of the electromagnetic applied products such as the dynamo-electric machines. Reducing a loss in the iron core sections contributes to realization of high efficiency of these products.

Further, as another measure to improve the efficiency, permanent magnets with a strong magnetic force are used. In this case, magnet torque per given current is increased to obtain necessary torque with low current, so that a loss (copper loss) caused by Joule heat of a conductor due to current is reduced.

Patent Document 1 proposes a method of increasing the efficiency of a permanent magnet motor. Patent Document 1 describes that low-loss amorphous is used as a soft magnetic material for the permanent magnet motor to form an axial gap-type motor. Further, as a structure for increasing the volume of a permanent magnet to reduce a copper loss, a motor is configured to have rotors on two surfaces in the shaft direction. As a possible general structure to increase the capacity of the axial gap motor, the radius is increased as means for increasing the area where a stator faces a rotor through a gap. However, the length of the axial gap-type motor is short in the shaft direction. Thus, if the radius is increased, the shape becomes considerably flattened, which is inconvenient for use.

Patent Document 2 proposes a method of solving the above-described problem. Patent Document 2 shows a structure in which plural stators are provided in the shaft direction, and rotors associated with the stators are disposed in the shaft direction to increase an output. The rotational shafts of the plural rotors in the shaft direction are coupled to one output shaft to output combined torque, so that severalfold torque can be output.

### PRIOR ART DOCUMENT

### Patent Document

Patent Document 1: Japanese Patent Application Laid-Open No. 2010-115069
Patent Document 2: Japanese Patent Application Laid-Open No. 2008-136348

### SUMMARY OF THE INVENTION

### Problem to be Solved by the Invention

A problem in Patent Document 2 is that all the rotors need to be coupled to the output shafts for the rotors. In the case of the axial gap motor, the stator is sandwiched between the rotors in the shaft direction. Accordingly, it is impossible that the rotors are assembled in advance, and then are combined with the stator. Thus, the following method is necessary. One of the rotors is assembled to the shaft, and then is combined with one stator while keeping the positional relation. Thereafter, the next rotor is assembled to the shaft, and then is combined with the next stator while adjusting the positional relation.

However, the magnet of the axial gap-type magnet rotor is considerably strong in the absorption force. Thus, it is extremely difficult to determine the position in the shaft direction. In addition, a stress in the shaft direction is generated on the stator side due to a considerably-strong absorption force in the shaft direction during assembling. Thus, the stator needs to be assembled while being strongly fixed. The more the number of stages increase, the more the positioning and assembling while being fixed become difficult.

An object of the present invention is to provide a low-cost and high-performance motor unit, and a dynamo-electric machine and a dynamo-electric machine device that use the same while satisfying large capacity and easy assembly without increasing the size of the axial gap motor in the radial direction.

### Means for Solving the Problem

In order to solve the above-described problems, the present invention provides a dynamo-electric machine, wherein a motor unit includes: an in-unit shaft; a stator that is provided at the in-unit shaft in the circumferential direction; two rotors that are rotated together with the in-unit shaft and are provided while facing the both surfaces of the stator in the circumferential direction; and

engagement sections that are provided on the both surfaces of the rotors on the sides opposite to the stator, and plural motor units are engaged at the engagement sections to be integrally rotated.

Further, the dynamo-electric machine includes: brackets that are provided on the both end sides of the plural motor units in the shaft direction; a housing that covers the circumferential direction of the plural motor units; and a shaft unit that is disposed between the brackets located at the both ends in the shaft direction and the plural motor units and includes a disc section and a shaft section, and the shaft section of the shaft unit is rotatably held at the brackets, and the engagement sections are provided on the surface of the disc section facing the motor unit, so that the shaft unit is engaged with the plural motor units at the engagement sections to be integrally rotated.

Further, the engagement sections include holes set on the surface, and the holes and those on the opposed surface are coupled to each other through coupling pins.

Further, the holes to engage the plural motor units with each other are disposed at the positions where the axial angle same as the rotational shaft can be kept.

Further, a concave-structure mate fitting is formed on one surface on which each of the plural motor units is engaged at the engagement sections and a convex-structure mate fitting is formed on the other surface on which each of the plural motor units is engaged at the engagement sections to form a fitting section obtained by fitting the concave portion and the convex portion to each other.

Further, the engagement sections include a concave-structure mate fitting formed on one surface where the plural motor units face and a convex-structure mate fitting formed on the opposed surface, and D-cut coupling is realized by the concave portion and the convex portion.

Further, the plural motor units are produced to have the same number of slots and poles, and a shift angle at the position where the plural motor units are engaged at the engagement sections is set at an angle by which cogging torque generated by the motor units is cancelled.

Further, the shift angle from the central axis of the position where the plural motor units are engaged at the engagement sections is 360 degrees/(6×(the number of pole pairs)).

Further, in the case where even numbers of motor units are combined together, the half is set at 0 degree and the rest is set at the shift angle.

Further, in the case where odd numbers of motor units are combined together, the motor units are disposed while being overlapped with each other by 1/(n−1) degrees of the basic cycle of cogging torque.

Further, the present invention provides a dynamo-electric machine device configured to drive a machine mechanism including a rotational shaft with the dynamo-electric machine, wherein the engagement sections are provided on the end surface of the machine mechanism in the circumferential direction facing the motor unit rotor, so that the machine mechanism is engaged with the plural motor units at the engagement sections to be integrally rotated.

Further, the machine mechanism and the plural motor units are arranged in the order of the machine mechanism and the plural motor units in the shaft direction.

Further, the machine mechanism is arranged at the position sandwiched between the plural motor units in the shaft direction.

In order to solve the above-described problems, the present invention provides a motor unit including: an in-unit shaft; a first rotor that is fixed to one end of the in-unit shaft and has plural permanent magnets in the circumferential direction; a stator that is attached from the other end of the in-unit shaft through a bearing; and a second rotor that is fixed to the other end of the in-unit shaft and has plural permanent magnets in the circumferential direction, wherein engagement sections are provided on the surfaces of the first rotor and the second rotor on the sides opposite to the stator.

Further, the first rotor is attached to one end of the in-unit shaft, the stator is attached to the other end of the in-unit shaft through the bearing, and then the second rotor is fixed to the other end of the in-unit shaft.

Further, plural motor units are engaged at the engagement sections to be integrally rotated.

Further, in order to solve the above-described problems, the present invention provides a dynamo-electric machine device that drives a machine mechanism including a rotational shaft with a motor unit, wherein the motor unit includes: an in-unit shaft; a stator that is provided at the in-unit shaft in the circumferential direction; two rotors that are rotated together with the in-unit shaft and are provided while facing the both surfaces of the stator in the circumferential direction; and engagement sections that are provided on the both surfaces of the rotors on the sides opposite to the stator, the machine mechanism including the rotational shaft includes engagement sections on the end surface in the circumferential direction of the rotational shaft, and the engagement sections of the machine mechanism are engaged with those of the motor unit, so that the machine mechanism and the motor unit can be integrally rotated.

Further, the machine mechanism is a flywheel fastened using the engagement sections of the motor unit.

Further, the machine mechanism is sensor means that detects the rotational angle of the motor unit.

Further, the machine mechanism is gear means having two shafts, the engagement sections on the end surfaces in the circumferential direction of the respective shafts of the gear means and the engagement sections of the motor units are engaged with each other to be integrally rotated, the motor units that drive the respective shafts have the numbers of poles that are different from each other, and the motor units are operated at a constant ratio of the number of revolutions.

Further, the machine mechanism is a coupling control mechanism such as a clutch mechanism provided between plural motor units through the engagement sections, and uncoupling and refastening in the shaft direction can be controlled.

Further, the machine mechanism is a driving shaft for a vehicle.

Further, the plural motor units are driven by plural inverters.

### Effect of the Invention

According to the present invention, the shafts of the rotors are not integrally formed unlike the publicly known documents. Thus, an assembly process of the motor itself can be advantageously simplified. In addition, only by manufacturing the same motor units in large quantity, high-output motors can be advantageously configured. Further, because an assembly method is simple, low cost can be realized. In addition, windings and stator iron cores can be densely mounted, so that high output and density can be expected.

### BRIEF DESCRIPTION OF THE DRAWINGS

FIG. 1 is a perspective exploded view of a dynamo-electric machine having axial gap motor units.

FIG. 2 is a perspective exploded view of the axial gap motor unit.

FIG. 3 is a diagram for showing disposition of a stator iron core, a coil, and a bearing holding section.

FIG. 4 is an exploded perspective view of a stator 5 of FIG. 2.

FIG. 5a is a diagram for showing an example of a structure of engagement sections between the axial gap motor units.

FIG. 5b is a diagram for showing a modified example of a structure of engagement sections between the axial gap motor units.

FIG. 5c is a diagram for showing an example of a coupling structure without using coupling pins.

FIG. 5d is a diagram for showing an example of fastening an output shaft unit to a rotor yoke.

FIG. 6a is a diagram in which motor units having the same configuration are fastened to each other at the same position in the rotational direction.

FIG. 6b is a diagram in which the fastened position of the motor units having the same configuration is shifted.

FIG. 6c is a diagram for showing cogging torque when being fastened at the same position in the rotational direction.

FIG. 6d is a diagram for showing cogging torque when the fastened position is shifted.

FIG. 7a is a diagram for showing an example of a dynamo-electric machine device configured using motor units and a driving target.

FIG. 7b is a diagram for showing a modified example of a dynamo-electric machine device configured using motor units and a driving target.

FIG. 7c is a diagram for showing a modified example of a dynamo-electric machine device configured using motor units and a driving target.

FIG. 7d is a diagram for showing a modified example of a dynamo-electric machine device configured using motor units and a driving target.

FIG. 7e is a diagram for showing a modified example of a dynamo-electric machine device configured using motor units and a driving target.

FIG. 7f is a diagram for showing a modified example of a dynamo-electric machine device configured using motor units and a driving target.

FIG. 8a is a diagram for showing a method in which two motors are controlled by one inverter.

FIG. 8b is a diagram for showing a method in which two motor units are controlled by two inverters.

FIG. 9 is a diagram for showing an example in which the dynamo-electric machine of the present invention is mounted on an automobile wheel driving system.

### BEST MODE FOR CARRYING OUT THE INVENTION

Hereinafter, embodiments of the present invention will be described using the drawings.

### First Embodiment

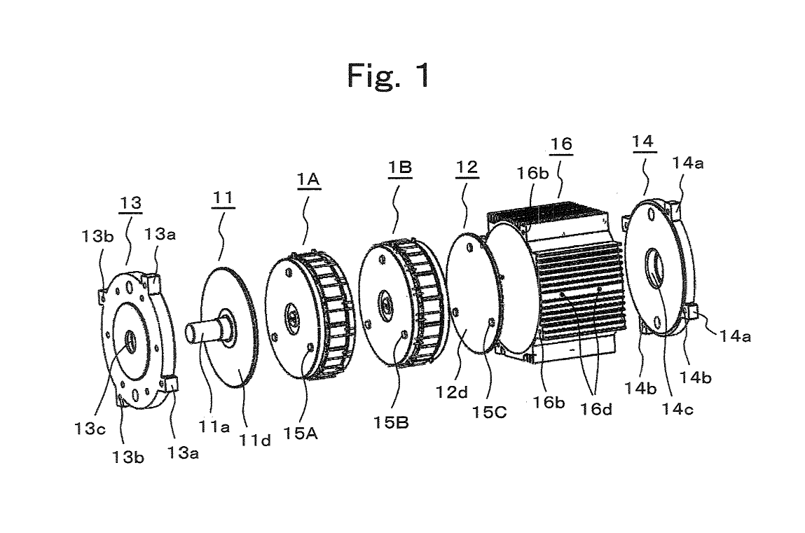

Hereinafter, a first embodiment of a dynamo-electric machine according to the present invention will be described using FIG. 1 to FIG. 3.

FIG. 1 is a perspective exploded view for showing a structure of a dynamo-electric machine having two axial gap motor units in the shaft direction. In the drawing, the reference numeral 16 denotes a motor housing at left and right ends of which an output shaft-side bracket 13 and a rear end-side bracket 14 are attached, respectively. In order to attach the housing and the brackets to each other, holes 13b and 14b are provided at attachment sections 13a and 14a of the brackets 13 and 14, respectively. On the other hand, the holes 13b and 14b are fixed to holes 16b provided at opposed areas of the housing 16 by screws.

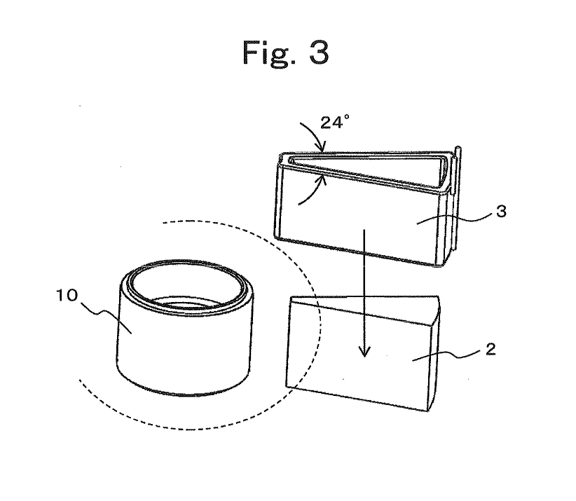

Further, between the two brackets 13 and 14, disposed are an output shaft 11, two sets of motor units 1A and 1B in this example, and a rear end section shaft 12. These members are formed as an integrally-rotating structure in which the members are provided with engagement sections on the surfaces in the vertical direction relative to the rotational shaft, and are overlapped with each other to be fixed at the engagement sections. For the structure fixed at the engagement sections, there are some methods which will be described later using FIG. 3. In FIG. 1, there will be described an integrally-rotating structure in which holes are provided on the both surfaces of each of members that are overlapped with each other, and pins are engaged with the holes to fix the members.

In terms of the structure fixed at the engagement sections, a fixed structure between the motor units 1A and 1B will be described first. The two sets of motor units 1A and 1B shown in the middle of the shaft direction of FIG. 1 configure an axial gap-type motor having disc-like rotors on the both surfaces in the shaft direction. The motor units 1A and 1B illustrated are provided with holes for disposition of coupling pins at plural positions (three positions at equal angle pitches in the drawing) in the rotational direction on the both ends (back surfaces of rotor yokes) of the respective rotors in the shaft direction. Coupling pins 15A and 15B are disposed in the holes. In short, the motor units 1A and 1B are coupled to each other in the example of FIG. 1 in such a manner that the holes are provided on the both surfaces of each of the motor units 1A and 1B and the coupling pins are disposed between the holes to be engaged.

The coupling pins 15B illustrated on the left side in the shaft direction of the motor unit 1B on the right side of the drawing are connected to holes (not shown) for disposition of coupling pins on the back surface of the rotor yoke illustrated on the right side in the shaft direction of the motor unit 1A on the left side of the drawing, and the rotors of the motor unit 1A and the motor unit 1B are integrally and rotatably coupled to each other. It should be noted that an example of providing the two sets of motor units 1A and 1B is shown in FIG. 1. However, three or more units can be connected to each other in a similar manner.

Next, a coupling structure between the motor unit 1 and the shaft will be described. The motor unit 1 and the shaft are coupled to each other at the engagement sections of the pins and the holes. The shaft includes the output shaft 11 and the rear end section shaft 12. Of these, the output shaft 11 is configured using a shaft section 11a and a disc section 11d, and has the disc section 11d at one end of the shaft section 11a. The disc section 11d is positioned on the side where the motor unit 1A faces, and has coupling pins on the rear surface as similar to the back surface of the rotor of the motor unit. The coupling pins 15A disposed on the front surface of the motor unit 1A are engaged with the coupling holes, and the disc section 11d is rotatable integrally with the rotor of the motor. It should be noted that when being assembled in the motor housing 16, the shaft section 11a of the output shaft 11 is rotatably attached to a rotation engagement hole 13c of the output shaft-side bracket 13.

The rear end section shaft 12 that is another shaft is configured using a shaft section and a disc section 12d, and may be assumed as being disposed by inverting the output shaft 11. The disc section 12d is positioned on the side where the motor unit 1B faces, and holes are provided on the front surface as similar to that of the rotor of the motor unit. Coupling pins 15c are engaged with the holes, so that the disc section 12d is rotatable integrally with the rotor of the motor. It should be noted that when being assembled in the motor housing 16, the shaft section of the rear end section shaft 12 is rotatably attached to a rotation engagement hole 14c of the rear end-side bracket 14, which cannot be seen because they are hidden behind the disc section 12d. Accordingly, the rotational shaft is rotated by fixing the stator as similar to a general motor.

It should be noted that the output shaft 11 and the rear end section shaft 12 are symmetrically disposed in the combined structure of FIG. 1, and the basic structures are the same. However, the lengths of the shaft sections are different from each other. It is only necessary for the shaft section of the rear end section shaft 12 to have a length enough to be rotatably attached to the rear end-side bracket 14. However, it is necessary for the shaft section 11a of the output shaft 11 to have a length enough to be rotatably attached to the output shaft-side bracket 13 and to transmit an output of the shaft to the outside.

As a result, when the motor is assembled in the present invention, it is only necessary to sequentially combine the respective members while disposing the pins 15 at the positions of the holes in accordance with the arrangement order of the members illustrated in FIG. 1. Then, the output shaft 11, the rear end section shaft 12, and the motor units 1A and 1B are integrally configured to be disposed in the motor housing 16. In this case, the outer circumference of the stator is fixed to the motor housing 16 using fixing holes 16d. Further, a bearing is disposed at each of the rear end section shaft 12 and the output shaft 11. Then, the bearings are rotatably held by the output shaft-side bracket 13 and the rear end-side bracket 14 to configure the motor. Accordingly, it is possible to realize a structure of the motor in which only the output shaft 11a is rotatably disposed from the assembled housing 16 and brackets 13 and 14.

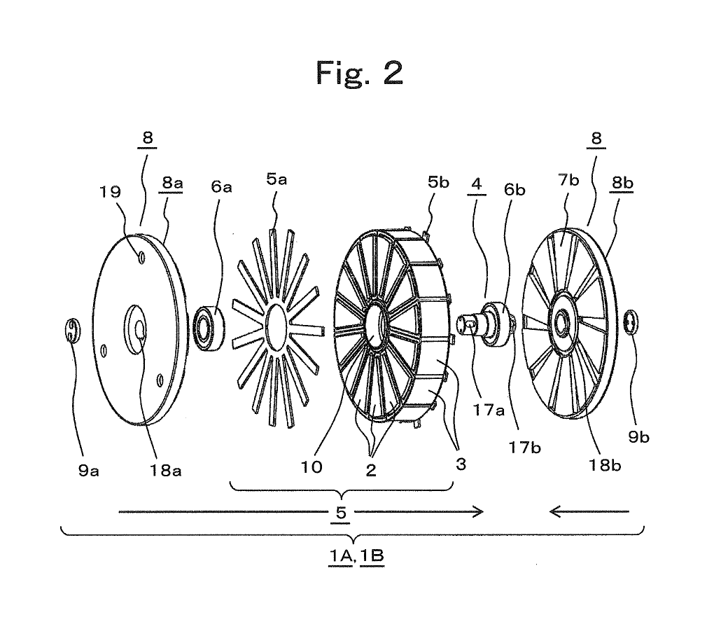

FIG. 2 obliquely shows a structure of the axial gap motor configuring the motor units 1A and 1B. In the present invention, the axial gap motor itself is configured as one unit. It should be noted that the axial gap motor having the rotors on the both surfaces with 15 slots and 10 poles is shown as an example.

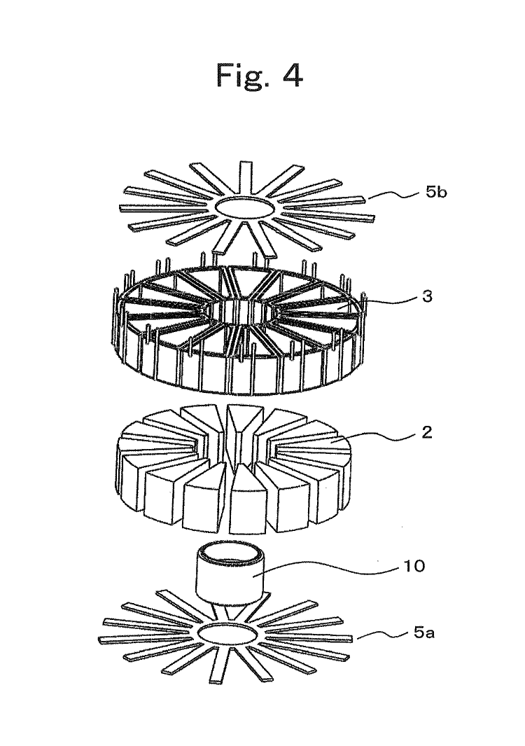

A stator 5, two rotors 8 disposed at both ends of the stator, an in-unit shaft 4, and the like are main members configuring the axial gap motor unit of FIG. 2. Of these members, the structure of the stator 5 will be described later in detail with reference to FIG. 3 and FIG. 4. These main members are configured using some additional members. The structures of the main members will be described together with materials and characteristics suitable for each member.

In FIG. 2, fifteen stator iron cores 2 configuring the stator 5 are formed in a substantially fan shape or a substantially trapezoidal shape. The iron cores 2 are configured using an electromagnetic steel sheet and a high-permeability and soft magnetic material such as amorphous, a powder magnetic core, and metallic glass. In the case where the iron cores 2 are configured using an electromagnetic steel sheet and amorphous, a structure configured by laminating thin plates on each other (the lamination direction is the radial direction or the circumferential direction) is employed so as to suppress overcurrent generated due to changes of magnetic flux.

A unit structure of the stator iron core 2 is shown in FIG. 3. FIG. 3 is a diagram for showing the disposition of the stator iron core, a coil, and a bearing holding section. Around the stator iron core 2 formed in a substantially fan shape or a substantially trapezoidal shape, disposed is the stator coil 3 having a shape similar to the outer shape of the stator iron core. The stator coils are circumferentially disposed around the bearing holding section 10. Thus, the stator coils are mounted at areas each having a predetermined angle (24 degrees in the drawing because of 15 slots). In the example of FIG. 3, fifteen stator coils 3 are installed around the bearing holding section 10.

FIG. 4 is an exploded perspective view of the stator 5 of FIG. 2, and fifteen stator iron cores 2 are disposed in the circumferential direction of the bearing holding section 10. Further, the stator coil 3 is wound around each of the stator iron cores 2.

The bearing holding section 10 disposed in the middle around which the stator iron cores 2 and the stator coils 3 are disposed in the circumferential direction is configured using metal such as aluminum or stainless steel. The bearing holding section 10 has a function of holding a bearing therein at the both ends in the shaft direction, and has a structure with a step in which the position of the bearing is determined and secured in the shaft direction.

As being well characterized in FIG. 4, the coils 3 and the stator iron cores 2 are held with stator holding plates 5a and 5b to hold the stator 5 from the both sides. The stator holding plates 5a and 5b are brought into contact with the coils 3 through insulation. Each of the stator holding plates 5a and 5b has a function of transmitting heat generated from the coils 3 to the housing 16 and a reinforcing function of holding the coils 3 and the iron cores 2 to secure intensity as a structural object.

Therefore, it is necessary to use a material with a high intensity for the stator holding plates 5a and 5b, and it is desirable to use non-magnetic metal such as aluminum or stainless steel. In the case of using the metal as described above, when the ends of the stator holding plates 5a and 5b in the radial direction are brought into contact with the metal housing 16, overcurrent blocking magnetic flux is generated due to the magnetic flux passing through the stator iron cores 3. Thus, it is necessary to configure the stator holding plates in such a manner that two of three in the circumferential direction are not brought into contact with the housing 16. FIG. 2 shows the disposition after being assembled as the stator. When paying attention to the stator holding plate 5b, it can be found that some parts largely protrude from the circumferential portion, but others do not. The parts largely protruding from the circumferential portion are brought into contact with the housing 16 to fix the stator to the housing. When fixing, the fixing holes 16d of the housing 16 are used.

Further, in the case where the housing is made of non-conductive material, all the ends may be brought into contact with the housing. In addition, in the case where the stator holding plates 5a and 5b are configured using reinforced plastic, silica, or ceramics to have intensity as reinforcing steel, it is not necessary to consider overcurrent. Thus, the ends of the stator holding plates 5a and 5b may be brought into contact with the metal housing.

The stator iron cores 2, the stator coils 3, the bearing holding section 10, and the stator holding plates 5a and 5b are integrally held, and then are integrated by resin impregnation or resin molding in a die, so that the stator 5 is configured.

Rotor yokes 8a and 8b are disposed while facing the both surfaces of the stator 5 in the direction vertical to the stator shaft. As being characterized in the rotor yoke 8b of FIG. 2, ten permanent magnets 7b are disposed in a radial fashion from the central axis on the surface that faces the stator 5. Accordingly, the axial gap motor unit with 15 slots and 10 poles is configured. Further, as being characterized in the rotor yoke 8a of FIG. 2, holes 19 configuring engagement sections are provided on the surface that does not face the stator 5. Further, as being apparent from the above description, the coupling pins are disposed in the holes to configure the engagement sections.

The two sets of rotor yokes 8a and 8b produced and manufactured as described above and the molded stator 5 are coupled to each other through the motor in-unit shaft 4 as the central shaft section. Key grooves 17a and 17b are provided at the both ends of the motor in-unit shaft 4 to determine the position in the rotational direction. Although the key grooves are shown in this case, a D-cut structure or a positioning pin hole structure may be employed if they are means to determine the position in the rotational direction.

On the right side of the motor in-unit shaft 4 in the shaft direction shown in the drawing, disposed is a motor in-unit bearing 6b assembled from the right direction. The position of the motor in-unit bearing 6b in the shaft direction is determined on the basis of the dimension of a thick shaft section in the middle of the motor in-unit shaft 4 in the shaft direction. The rotor yoke 8b having a key groove 18b is assembled on the right side of the motor in-unit bearing 6b, and is fastened by an end cap 9b.

The motor in-unit shaft 4 assembled with the rotor yoke 8b is assembled while holding the bearing from the right side in the inner circumference of the bearing holding section 10 of the stator. Next, a motor in-unit bearing 6a and the rotor yoke 8a having a key groove 18a functioning to determine the position in the rotational direction are similarly assembled from the left side of the motor in-unit shaft 4 symmetrical in the shaft direction. Finally, the motor in-unit shaft 4 is similarly fastened to the rotor yoke 8a by an end cap 9a from the left side. The plural holes 19 for disposition of the coupling pins are provided in the rotational direction on the both end sides of the rotor yokes 8a and 8b in the shaft direction as shown in the drawing.

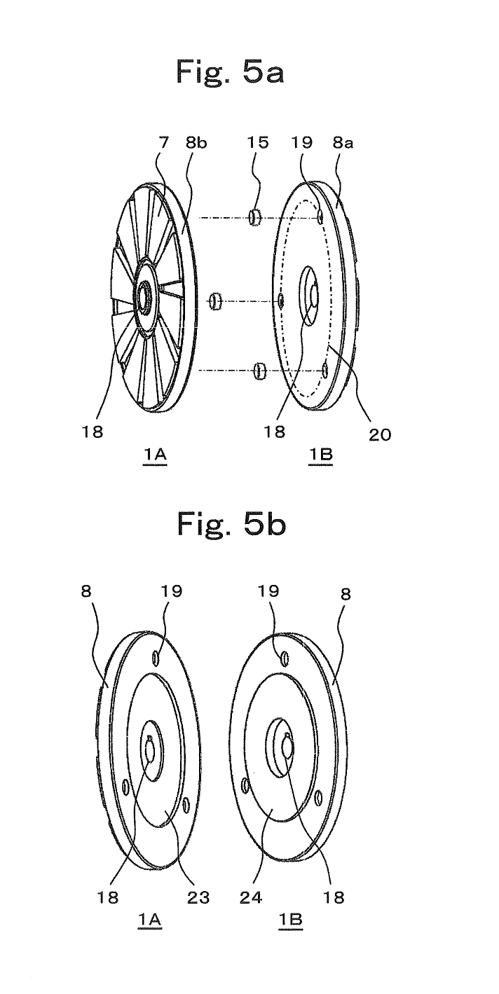

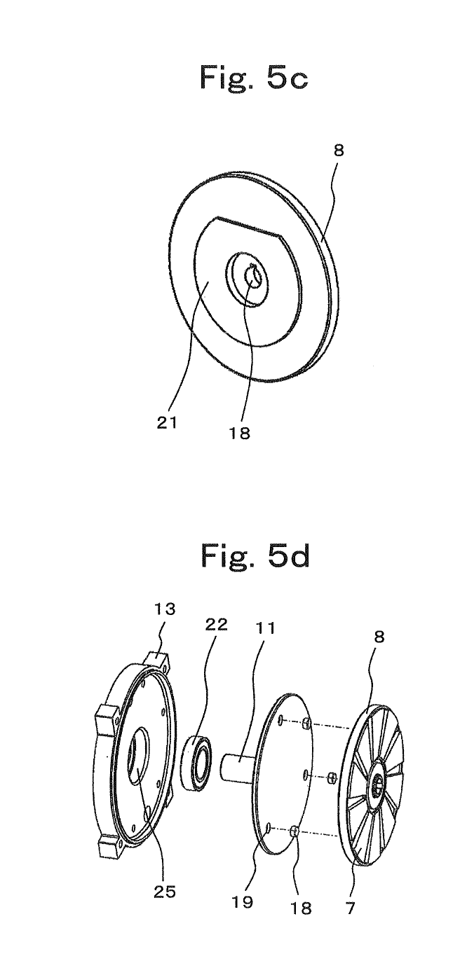

FIG. 5 show several detailed explanatory diagrams related to the engagement section structure to fasten the members such as the rotors in the shaft direction. First, FIG. 5a shows an example of the engagement section structure between the axial gap motor units 1A and 1B. The example shows a structure of rotatably fastening using the coupling pins shown in FIG. 1 and FIG. 2. On the back surfaces (on the outer surfaces in the shaft direction) of the rotor yoke 8b of the axial gap motor unit 1A and the rotor yoke 8a of the unit 1B, provided are the holes 19 at three positions at equal pitches of 120 degrees in the circumferential direction of a concentric circle 20 keeping the axial angle same as that of an insertion hole 18 of the motor in-unit shaft 4. The rotors having the same structure are synchronized with each other while disposing the fastening pins 15 in the holes 19 on the back surfaces of the rotor yokes so as to be rotatable about the rotational shaft of the motor in-unit shaft 4.

FIG. 5b shows a modified example of the engagement section structure to fasten the rotors in the shaft direction. In this case, a convex-shaped mate fitting 24 coaxial with and having the axial angle same as that of the motor in-unit shaft 4 is provided at the axial gap motor unit 1B. In addition, a concave-shaped mate fitting 23 coaxial with and having the axial angle same as that of the motor in-unit shaft 4 is provided at the disc illustrated on the left side in the drawing in the axial gap motor unit 1A. These mate fittings are combined to each other, so that the same axial angle of the two discs can be kept. The holes 19 in which the fastening pins are disposed are provided to transmit the rotational force. Accordingly, the holes 19 for disposition of the coupling pins can realize the rotational fastening with a configuration in which the equal angle pitches on the rotation circumference are kept even if the same axial angle is not specified. Accordingly, the holes 19 for disposition of the coupling pins may be formed in a long hole shape (rectangle shape) long in the radial direction.

FIG. 5c shows an example of a coupling structure in which no coupling pins are used. FIG. 5c shows a structure in which a convex-shaped mate fitting 21 to keep the same axial angle is provided and a part of the mate fitting is cut out to form the convex portion 21 in a D-cut shape. The disc coupled on the opposite side is provided with a concave-shaped mate fitting to be combined thereto, so that the rotational fastening can be realized while keeping the same axial angle.

FIG. 5d shows an example in which the output shaft unit 11 is fastened to the rotor yoke 8. As shown in FIG. 1 and FIG. 2, fastening pins 18 are used. As similar to the detailed structure shown in FIG. 5a, FIG. 5d shows a structure in which the fastening pins 18 are disposed in the holes 19 disposed while keeping the same axial angle, and the rotor yoke 8 is fastened to the output shaft unit 11. Further, the drawing shows a configuration in which an output-side bearing 22 is disposed at the output shaft unit 11 fastened as described above, and is held by a bearing holding section 25 of an output-side bracket 23.

### Second Embodiment

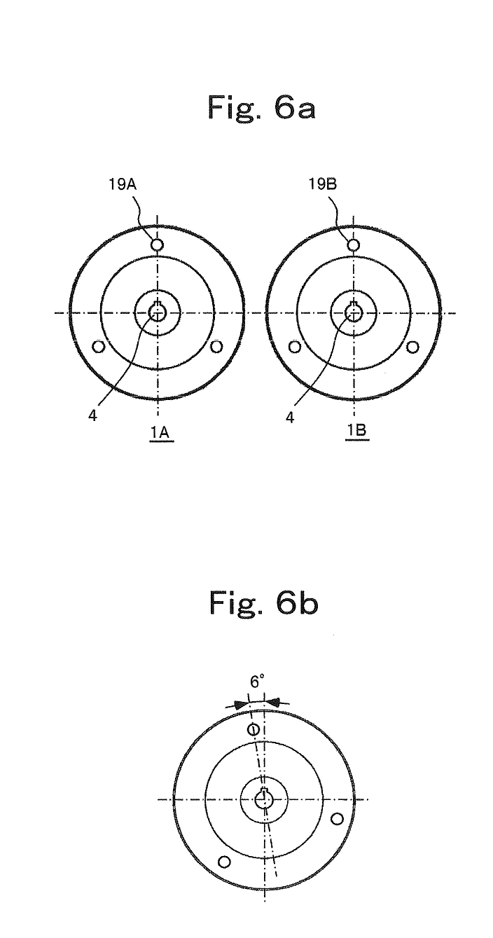

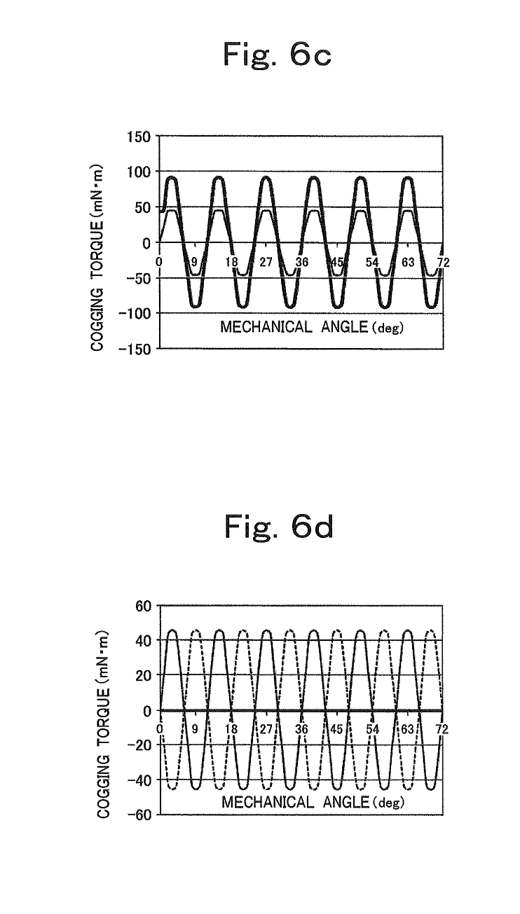

Next, a second embodiment of the present invention will be described using FIG. 6. In the embodiment, a device to reduce cogging torque will be described. The first embodiment shows an example in which the similarly-configured motor units are fastened to each other at the same position in the rotational direction. However, the motor units are shifted by a predetermined angle to be fastened to each other in the second embodiment. It should be noted that “similarly-configured” means that the motor units have the same number of slots and poles.

FIG. 6a shows a fastening relation of the first embodiment. When paying attention to a relation between the positions of the key grooves disposed in the insertion holes of the motor in-unit shaft 4 in the middle and the disposition of the holes 19 for disposition of the fastening pins, it can be found that the two axial gap motor units 1A and 1B are structured so that 19A and 19B are disposed at the positions same as the key grooves.

FIG. 6c shows how the cogging torque changes in this case. The motor unit 1A and the motor unit 1B have the same characteristics of the cogging torque. The cogging torque of each motor unit is represented by a thin line (characteristics in which the peak is 45 mNm) shown in FIG. 6c. The two motor units are overlapped with each other in the shaft direction, the torque is overlapped with another as represented by a thick line (characteristics in which the peak is 90 mNm) in the drawing. The peak value of the cogging torque when n-pieces of motor units are combined together is expressed as n times that of the basic unit.

Accordingly, in order to reduce the cogging torque, the holes 19 for disposition of the fastening pins in FIG. 6b are disposed while being shifted by an angle of 6 degrees relative to the key groove. Accordingly, the motor unit 1A and the motor unit 1B are operated while being overlapped by a mechanical angle of 6 degrees. In the motors shown in FIG. 1 and FIG. 2, the cycle of the cogging torque is 12 degrees, and thus the cogging torque is mutually cancelled by overlapping by 6 degrees that is half of 12 degrees, so that the fluctuation of the torque can be reduced to 0.

The reason is as follows. The basic cycle of the cogging torque has six orders per one cycle of an electric degree in many cases. Thus, the basic disposition angle is set at 360/(6×/(the number of pole pairs)), so that angle pitches in consideration of the cogging torque can be set from the time of designing. In the embodiment, the number of pole pairs is 10, and thus the motor unit is shifted only by 6 degrees.

FIG. 6d shows the result thereof, and the cogging torque obtained by combining the cogging torque (solid line) of the motor unit 1A and the cogging torque (dotted line) of the motor unit 1B that is shifted by 6 degrees and has the same characteristics becomes zero without pulsation as represented by a thick line.

It should be noted that in the case where even numbers of basic motor units are combined together, the half thereof is set at 0 degree and the rest is set at 6 degrees. Accordingly, the cogging torque can be reduced. Further, in the case where odd numbers n of basic motor units are combined together, they are disposed while being overlapped with each other by 1/(n−1) degrees of the basic cycle of the cogging torque, so that the cogging torque can be reduced. It should be noted that when overlapping, the angle shift and the overlapping order may be arbitrarily set.

### Third Embodiment

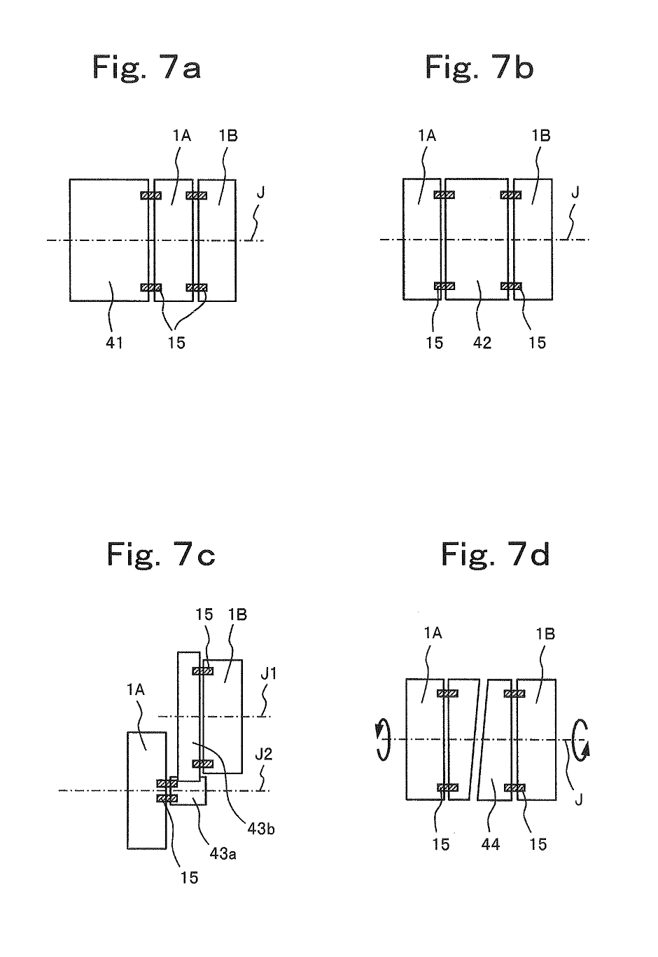

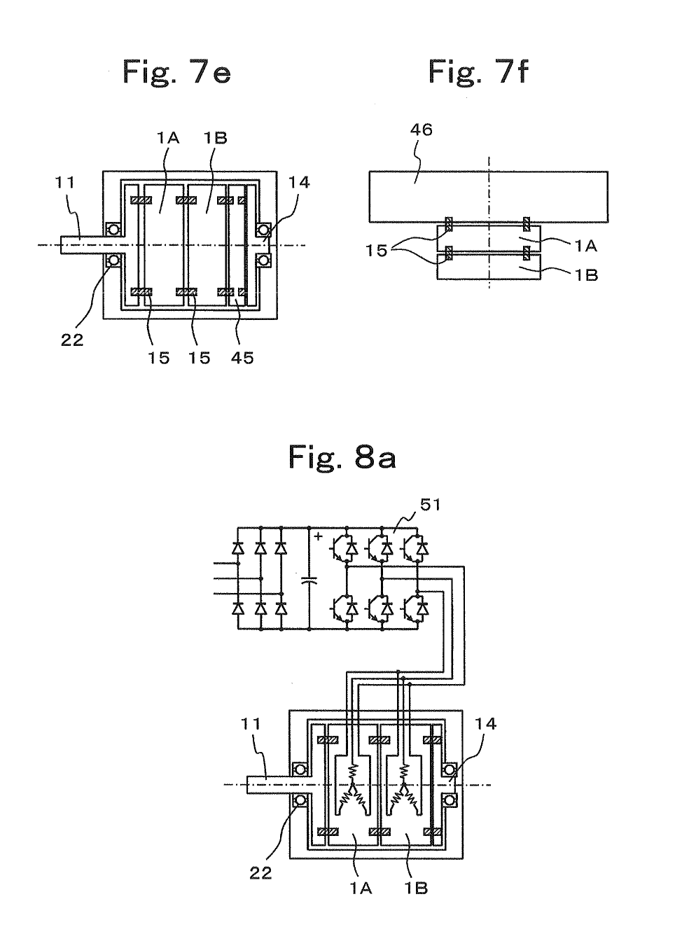

Next, a third embodiment of the present invention will be described using FIG. 7. In the embodiment, a dynamo-electric machine device configured by combining plural axial gap motor units and driving targets will be described.

The above-described examples are those of configuring the dynamo-electric machine by combining the basic motor units together. FIG. 5 show a combination (dynamo-electric machine device) in consideration of driving targets driven by the motors.

In FIG. 7a, the reference numeral 41 denotes a machine mechanism such as a pulley, a gear, a pump impeller, or a fan. In the example, the motor units 1A and 1B are coupled to each other in the shaft direction through the coupling pins 15, and further the machine mechanism 41 driven by the motors is fastened through the coupling pins 15 as similar to the rotors of the motors, so that a packaged dynamo-electric machine device can be realized. The packaged dynamo-electric machine device can be configured without exposing shaft couplings and rotational objects. In addition, another motor unit can be easily added on the right side depending on the output capacity. It should be noted that J represented by a dashed-dotted line in the drawing shows the rotational shaft.

It should be noted that it is not necessary to use the shaft unit 11 or 12 of FIG. 1 in the example of FIG. 7a. The engagement sections such as holes are formed on the surface of the machine mechanism 41 in the circumferential direction of the rotational shaft, and the motor unit and the machine mechanism 41 are engaged with each other through pins, so that the machine mechanism 41 can be rotated integrally with the motor unit. With the structure, the dynamo-electric machine device can be downsized.

FIG. 7b shows an example of a configuration in which a machine mechanism 42 is sandwiched between the motor unit 1A and the motor unit 1B to be rotatably fastened through the coupling pins 15 as similar to the above. This configuration is advantageous in such a case that although the basic motor units 1A and 1B can be fastened to each other, the basic motor units 1A and 1B need to be separately disposed in the shaft direction for the reason of disposition space, or in such a case that power is required evenly from the both sides.

FIG. 7c is a diagram for showing disposition in which the basic motor unit 1A and the basic motor unit 1B that is different from the basic motor unit 1A are not located on the same axis. In the example, the machine mechanisms are represented by 43a and 43b, and are driven by the basic motor unit 1A and the basic motor unit 1B that is different from the basic motor unit 1A, respectively. The example is advantageous in such a case that disposition space is limited.

As a concrete case of the disposition, there is a case in which a pinion shaft 43a connected to the motor unit 1A is connected to a spur gear 43b having the number of cogs larger than that of the pinion shaft. In this case, the basic motor unit B fastened to the spur gear 43b needs to rotate at a speed different from that of the basic motor unit A. As a way of dealing with the case, such a configuration can be employed that the ratios of the numbers of pole pairs of the basic motor units A and B are set at the same ratio as the mechanical gear ratio. Further, in the case of using the motors with the same specification, it is conceivable that the number of revolutions is controlled by two control units.

FIG. 7d shows an example in which a power transmission cutoff mechanism such as a clutch mechanism that is rotatably fastened is provided between the motor unit A and the motor unit B. Accordingly, the output of the motors can be switched if needed. The operation of one motor can be stopped to realize an energy saving operation if not needed.

FIG. 7e shows a conceptual diagram configured as a motor. In the case of driving as a high-accuracy motor, a sensor unit is needed to detect the position of the rotor in some cases. FIG. 7e shows an example in which a rotational position detecting unit 45 is disposed in the motor, and a rotor section of the rotational position detecting sensor is integrally coupled to the rotor through coupling functions such as coupling pins. The rotational position detecting unit 45 is an optical or magnetic encoder, a resolver, or a Hall element, and is configured as a unit including a circuit board.

FIG. 7f shows a configuration in which a flywheel 46 is added to the configuration of the motor units to connect large inertia. This configuration is advantageous in such a case that using the flywheel effect, electric power is converted into kinetic energy to be accumulated, and large power is instantaneously input and output.

### Fourth Embodiment

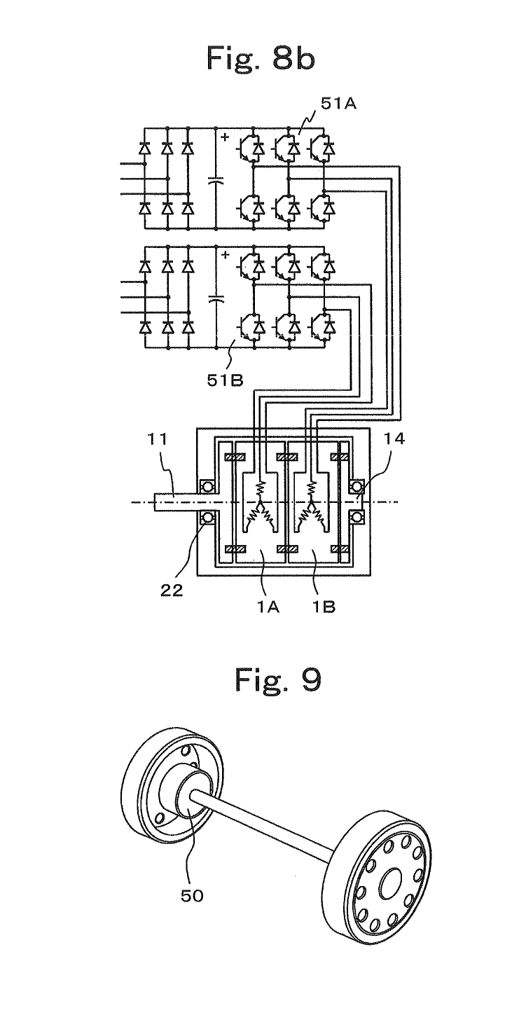

A fourth embodiment of the present invention will be described using the drawings. FIG. 8 are diagrams each showing a method of combining with a device (inverter) to control motors having the configuration of the present invention. Because two or more axial gap-type motors are provided, there are various possible control methods. FIG. 8a shows a method of controlling two motors 1A and 1B using one inverter 51. FIG. 8a shows a method in which terminals of Y-connections (the same applies to Δ-connections) of the two motors are connected in parallel to be controlled by one inverter 51. In the case of motors with the same specification, the motors can be controlled in the same way with the same voltage due to the parallel connection.

FIG. 8b shows a method of controlling two basic motor units 1A and 1B using two inverters 51A and 51B. In the method, the capacity of each of the inverters 51A and 51B may be small. In addition, one motor can be controlled as a motor, and the other can be controlled as an electric generator. It is advantageously conceivable that only one motor is operated to realize a power saving operation. It should be noted that the reference numerals 14 and 22 in FIG. 8 denote a rear-side end bracket and an output-side bearing, respectively.

### Fifth Embodiment

A fifth embodiment of the present invention will be described using FIG. 9. FIG. 9 shows an example in which the motor of the present invention is used as an in-wheel motor 50 of an electric car or a hybrid car. Only by increasing or decreasing the number of basic motor units, the output can be changed, so that motors with the same specification can be used for any cars irrespective of displacement. As described above, the motors can be applied to not only automobiles, but also a wide variety of fields such as industrial products and home appliances.

### INDUSTRIAL APPLICABILITY

The axial-type plural fastening structure motors of the present invention can be applied to a wide range of motors for the purpose of a small size, high efficiency, and low noise. Further, a system using the motor structure of the present invention can be widely applied to a general motor system such as a small-sized and high-efficiency fan, a pump system, a home-use motor, an automobile driving system, and wind power generation.

### DESCRIPTION OF REFERENCE NUMERALS

1A: first motor unit, 18: second motor unit, 2: stator iron core, 3: stator coil, 4: motor in-unit shaft, 5a, 5b: stator holding plate, 6a, 6b: bearing, 7: magnet, 8: rotor yoke, 9: shaft end cap, 10: bearing holding section, 11: output shaft unit, 12: rear-side shaft unit, 13: front-side end bracket, 14: rear-side end bracket, 15: fastening pin, 16: housing, 17: shaft-side key groove for positioning in the rotational direction, 18: rotor yoke-side key groove for positioning in the rotational direction, 19: fastening pin hole, 20: fastening pin hole disposition circle, 21: D-cut structure mate fitting protrusion, 22: output-side bearing, 23: mate fitting concave portion, 24: mate fitting convex portion, 25: output-side bearing holding section, 41: mechanical element, 42: mechanical element, 43a: pinion gear, 43b: spur gear, 44: clutch mechanism, 45: rotational position detection section, 46: flywheel, 51, 51A, 51B: three-phase inverter

1. A dynamo-electric machine, wherein
a motor unit comprises:
an in-unit shaft;
a stator that is provided at the in-unit shaft in the circumferential direction;
two rotors that are rotated together with the in-unit shaft and are provided while facing the both surfaces of the stator in the circumferential direction, and
engagement sections that are provided on the both surfaces of the rotors on the sides opposite to the stator, and plural motor units are engaged at the engagement sections to be integrally rotated.

2. The dynamo-electric machine according to claim 1, the machine
comprising:
brackets that are provided on the both end sides of the plural motor units in the shaft direction;
a housing that covers the circumferential direction of the plural motor units; and
a shaft unit that is disposed between the brackets located at the both ends in the shaft direction and the plural motor units and includes a disc section and a shaft section,
wherein the shaft section of the shaft unit is rotatably held at the brackets, and the engagement sections are provided on the surface of the disc section facing the motor unit, so that the shaft unit is engaged with the plural motor units at the engagement sections to be integrally rotated.

3. The dynamo-electric machine according to claim 1, wherein the engagement sections include holes set on the surface, and the holes and those on the opposed surface are coupled to each other through coupling pins.

4. The dynamo-electric machine according to claim 3, wherein the holes to engage the plural motor units with each other are disposed at the positions where the axial angle same as the rotational shaft can be kept.

5. The dynamo-electric machine according to claim 1, wherein a concave-structure mate fitting is formed on one surface on which each of the plural motor units is engaged at the engagement sections and a convex-structure mate fitting is formed on the other surface on which each of the plural motor units is engaged at the engagement sections to form a fitting section obtained by fitting the concave portion and the convex portion to each other.

6. The dynamo-electric machine according to claim 1, wherein the engagement sections include a concave-structure mate fitting formed on one surface where the plural motor units face and a convex-structure mate fitting formed on the opposed surface, and D-cut coupling is realized by the concave portion and the convex portion.

7. The dynamo-electric machine according to claim 1, wherein the plural motor units are produced to have the same number of slots and poles, and a shift angle at the position where the plural motor units are engaged at the engagement sections is set at an angle by which cogging torque generated by the motor units is cancelled.

8. The dynamo-electric machine according to claim 7, wherein the shift angle from the central axis of the position where the plural motor units are engaged at the engagement sections is 360 degrees/(6×(the number of pole pairs)).

9. The dynamo-electric machine according to claim 8, wherein in the case where even numbers of motor units are combined together, the half is set at 0 degree and the rest is set at the shift angle.

10. The dynamo-electric machine according to claim 8, wherein in the case where odd numbers of motor units are combined together, the motor units are disposed while being overlapped with each other by 1/(n−1) degrees of the basic cycle of cogging torque.

11. A dynamo-electric machine device configured to drive a machine mechanism including a rotational shaft with the dynamo-electric machine of claim 1, wherein the engagement sections are provided on the end surface of the machine mechanism in the circumferential direction facing the motor unit rotor, so that the machine mechanism is engaged with the plural motor units at the engagement sections to be integrally rotated.

12. The dynamo-electric machine device according to claim 11, wherein the machine mechanism and the plural motor units are arranged in the order of the machine mechanism and the plural motor units in the shaft direction.

13. The dynamo-electric machine device according to claim 11, wherein the machine mechanism is arranged at the position sandwiched between the plural motor units in the shaft direction.

14-23. (canceled)

24. The dynamo-electric machine according to claim 2, wherein the engagement sections include holes set on the surface, and the holes and those on the opposed surface are coupled to each other through coupling pins.

25. The dynamo-electric machine according to claim 24, wherein the holes to engage the plural motor units with each other are disposed at the positions where the axial angle same as the rotational shaft can be kept.

26. The dynamo-electric machine according to claim 2, wherein a concave-structure mate fitting is formed on one surface on which each of the plural motor units is engaged at the engagement sections and a convex-structure mate fitting is formed on the other surface on which each of the plural motor units is engaged at the engagement sections to form a fitting section obtained by fitting the concave portion and the convex portion to each other.

27. The dynamo-electric machine according to claim 2, wherein the engagement sections include a concave-structure mate fitting formed on one surface where the plural motor units face and a convex-structure mate fitting formed on the opposed surface, and D-cut coupling is realized by the concave portion and the convex portion.
